(19) United States
(12) Patent Application Publication
(10) Pub. No.: US 2024/0359367 A1
(43) Pub. Date: Oct. 31, 2024

(54) Material Separating Assemblies and Methods

(71) Applicant: Battelle Memorial Institute, Richland, WA (US)

(72) Inventors: Leonard F. Pease, Richland, WA (US); Michael J. Minette, Kennewick, WA (US); Carolyn A. Burns, Richland, WA (US); Raymond S. Addleman, Benton City, WA (US); Jason E. Serkowski, Richland, WA (US)

(73) Assignee: Battelle Memorial Institute, Richland, WA (US)

(21) Appl. No.: 18/649,076

(22) Filed: Apr. 29, 2024

Related U.S. Application Data
(60) Provisional application No. 63/462,596, filed on Apr. 28, 2023.
(60) Provisional application No. 63/575,097, filed on Apr. 5, 2024.

(51) Int. Cl. B29B 17/02

(52) U.S. Cl. CPC B29B 17/02; B29B 2017/0203; B29B 2017/0244

(57) ABSTRACT

Material separator assemblies are provided which can include: a conduit system configured to be arranged in relation to body forces; the system can include at least one linear section, which can include a length of opposing sidewalls defining a volume configured to receive a flow of mixed materials entering along a proximate end of the length, proceeding along the length, and exiting along a distal end of the length; and an exposed body force slide surface extending in the direction of the flow of materials along the linear section.

Methods for separating components of a mixture can include providing a mixture of components to a conduit having an exposed body force slide surface within a linear section of the conduit.

### CROSS REFERENCE TO RELATED APPLICATION

This application claims priority to and the benefit of U.S. Provisional Patent Application Ser. No. 63/462,596 filed Apr. 28, 2023, entitled “Modular Inline Particle Fractionators”, and U.S. Provisional Patent Application Ser. No. 63/575,097 filed Apr. 5, 2024, entitled “Material Separating Assemblies and Methods”, the entirety of each which is incorporated by reference herein.

### STATEMENT AS TO RIGHTS TO DISCLOSURES MADE UNDER FEDERALLY-SPONSORED RESEARCH AND DEVELOPMENT

This invention was made with Government support under Contract DE-AC05-76RL01830 awarded by the U.S. Department of Energy. The Government has certain rights in the invention.

### TECHNICAL FIELD

The present disclosure relates to material separation assemblies and methods. In some embodiments the assemblies and/or methods can be used to separate materials that are within a flowable matrix.

### BACKGROUND

Material separation assemblies and methods such as clarifiers and flocculators remove settled particles, and floatation unit operations remove both settled particles and skim off buoyant particles. However clarifiers, flocculators, and floatation units may operate, they typically have very large equipment sizes and long processing times.

Clarifiers are used across several industries from wastewater treatment and mining operations to geothermal silica handling and pharmaceutical manufacturing. Clarifiers increase the solids concentration at the bottom of the clarifier and reduce the solids concentration at the top of the clarifier. Because clarifiers rely on gravitational settling, and settling is often slow—particularly when the suspension is concentrated enough for hindered settling—clarifiers are often very large operations. For example, they can occupy the largest operation in square footage in most municipal water plants.

Settling ponds are commonly used in extraction industries ranging from mining to petroleum as a relatively inexpensive technique for settling particles out of processing streams. Once the solids have deposited (settled), the remaining fluid can be used as desired. Though once cheap, environmental regulations have substantially increased the cost of these ponds or prohibited them outright.

A key step in plastic recycling is the separation of plastic particles by density. The plastics that float typically have a different composition than the particles that settle. Most flotation systems are relatively slow and bulky.

Particle separation is a vital need for a variety of process intensive industries. For example, silica particles have to be removed from geothermal processes to permit downstream chemistries to extract lithium and rare earth metals; blood cells have to be removed from whole blood donations to prepare plasma; sand, proppant and other particles have to be removed from hydrocarbon streams; solids have to be removed from nuclear waste streams to separate low-and high-level waste streams from each other; and algae has to be harvested from concentrated algal suspensions. Industrial equipment to perform particle separation is typically slow, bulky, and unable to be operated in a dynamic manner. For example, clarifiers and open-air waste ponds and pits simply wait for gravity to settle particles so that the particle depleted fluid can be processed. Slow processes lead to large expensive processing equipment and large environmental footprints. Processes that need faster throughput often rely on centripetal forces (e.g., centrifuges) that often have moving parts or are smaller but still bulky. To intensify slurry processes, new approaches remain essential.

### SUMMARY

Material separator assemblies are provided. The assemblies can include: a conduit system configured to be arranged in relation to body forces; the system can include at least one linear section, the at least one linear section can include a length of opposing sidewalls defining a volume configured to receive a flow of mixed materials entering along a proximate end of the length, proceeding along the length, and exiting along a distal end of the length; and an exposed body force slide surface extending in the direction of the flow of materials along the linear section, the slide surface extending at an angle other than normal to the body forces.

Methods for separating components of a mixture can include: providing a mixture of components to a conduit having an exposed body force slide surface within a linear section of the conduit, the slide surface extending at an angle other than normal to the body forces acting upon the conduit; and separating components of the mixture upon the slide surface to form separated components of the mixture.

### BRIEF DESCRIPTION OF DRAWINGS

Embodiments of the disclosure are described below with reference to the following accompanying drawings.

FIG. 1 is a depiction of a cross section of a separation assembly according to an embodiment of the disclosure.

FIG. 2 is a pair of isometric cross sections of the separation assembly of FIG. 1 according to an embodiment of the disclosure.

FIG. 3 is an isometric view of a separation assembly according to an embodiment of the disclosure.

FIG. 4 is an isometric view of a separation assembly according to an embodiment of the disclosure.

FIG. 5 is an end view of a separation assembly according to an embodiment of the disclosure.

FIG. 6 is an isometric view of the separation assembly of FIG. 5 according to an embodiment of the disclosure.

FIG. 7 is an end view of a separation assembly according to an embodiment of the disclosure.

FIG. 8A is an isometric view of the separation assembly of FIG. 7 according to an embodiment of the disclosure.

FIG. 8B is an isometric view of another configuration of the separation assembly of FIG. 7 according to an embodiment of the disclosure.

FIG. 8C is another isometric view of the configuration of the separation assembly of FIG. 8B according to an embodiment of the disclosure.

FIGS. 9A-9D depict data acquired utilizing embodiments of separation assemblies according to the disclosure.

FIGS. 10A-10C depict data acquired utilizing embodiments of separation assemblies according to the disclosure.

FIGS. 11a-11d depict cross sectional views of separation assemblies according to embodiments of the disclosure.

FIG. 12A is a cross section of a separation assembly according to an embodiment of the disclosure.

FIG. 12B is a cut-away view of the separation assembly of FIG. 12A according to an embodiment of the disclosure.

FIGS. 13a-13d depict cross sectional views of separation assemblies according to embodiments of the disclosure.

FIGS. 14a-14d depict cross sectional views of separation assemblies according to embodiments of the disclosure.

FIG. 15 is an end view of a separation assembly according to an embodiment of the disclosure.

FIG. 16 is an isometric view of the separation assembly of FIG. 15 according to an embodiment of the disclosure.

FIG. 17 is an end view of a separation assembly according to an embodiment of the disclosure.

FIG. 18 is an isometric and cut away view of the separation assembly of FIG. 17 according to an embodiment of the disclosure.

FIG. 19 is an isometric view of the separation assembly of FIGS. 17 and 18 according to an embodiment of the disclosure.

FIG. 20 is a depiction of a separation assembly according to an embodiment of the disclosure.

FIG. 21 is a cut-away isometric view of a separation assembly according to an embodiment of the disclosure.

FIG. 22 is cross sectional view of a separation assembly according to an embodiment of the disclosure.

FIG. 23 is an isometric view of the separation assembly of FIG. 22 according to an embodiment of the disclosure.

FIG. 24 is another isometric view of the separation assembly of FIGS. 22 and 23.

### DESCRIPTION

This disclosure is submitted in furtherance of the constitutional purposes of the U.S. Patent Laws “to promote the progress of science and useful arts” (Article 1, Section 8).

This disclosure describes a new particle settler that replaces slow and very large equipment with fast small footprint mesofluidic settlers. Mesofluidic settlers can drive settling much faster with much smaller footprints (and less reduced odor). Mesofluidic settlers can drive settling within piping/channel systems, replacing the need for these ponds.

Mesofluidic settlers can settle larger particles efficiently. Mesofluidic systems can be used to separate plastic particles by density as well as partition particles that float as well.

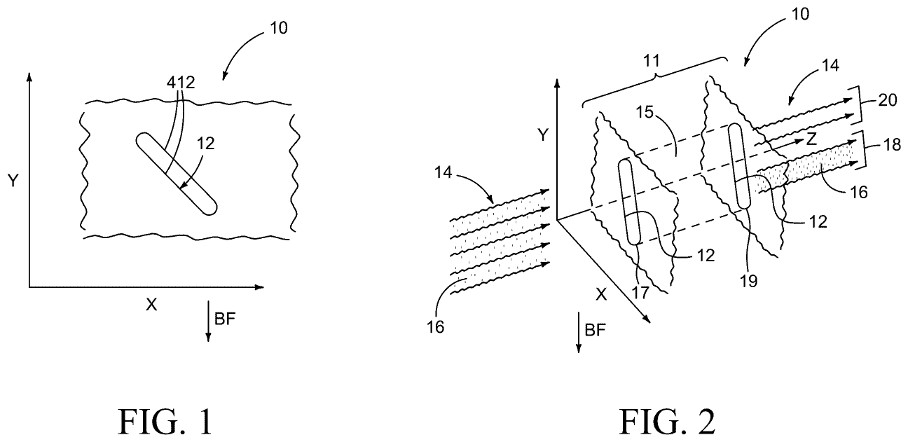

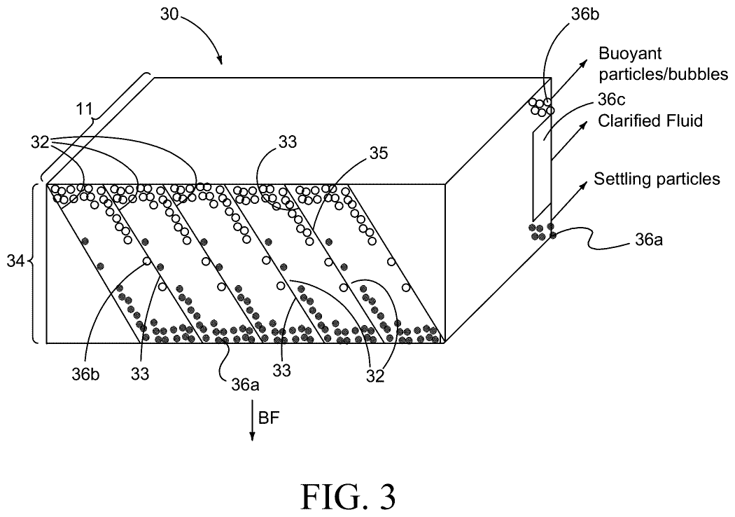

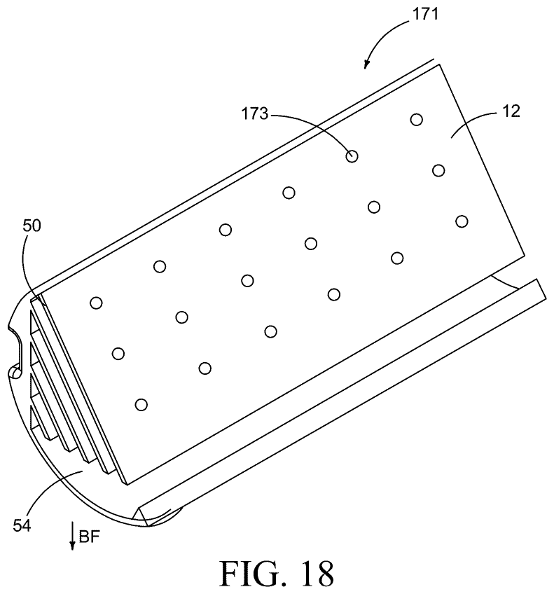

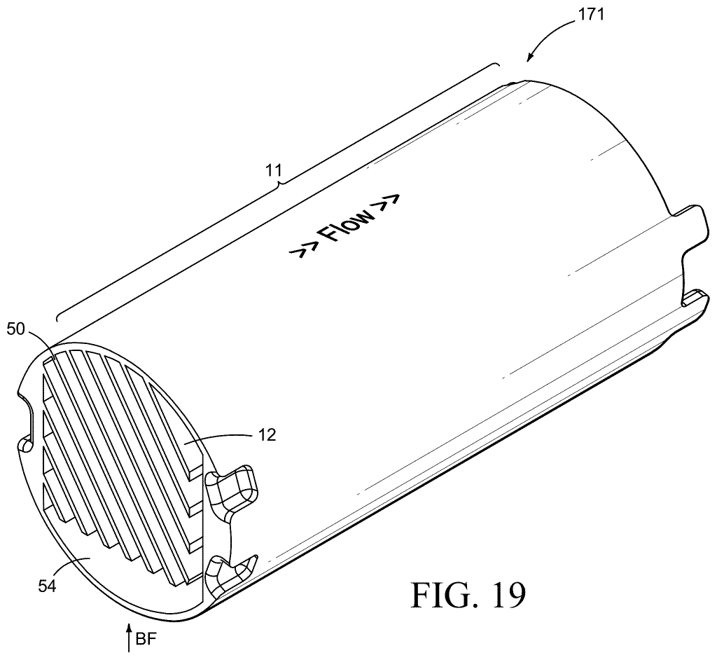

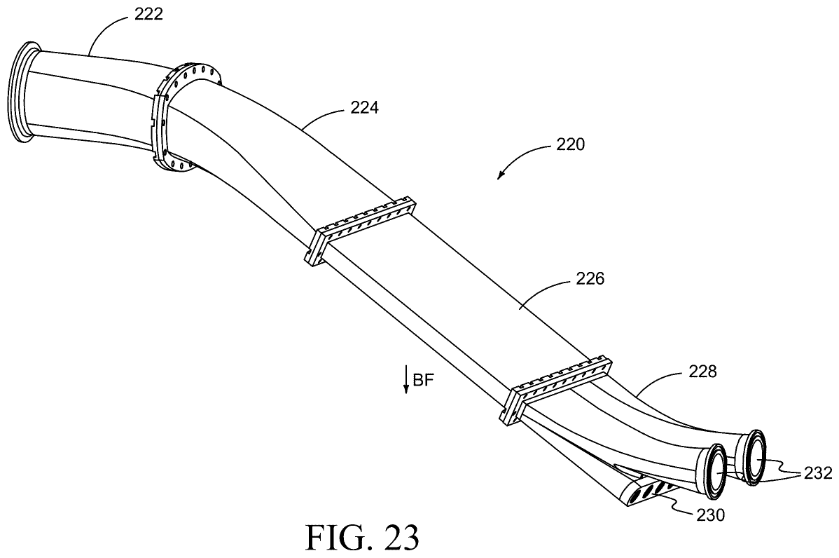

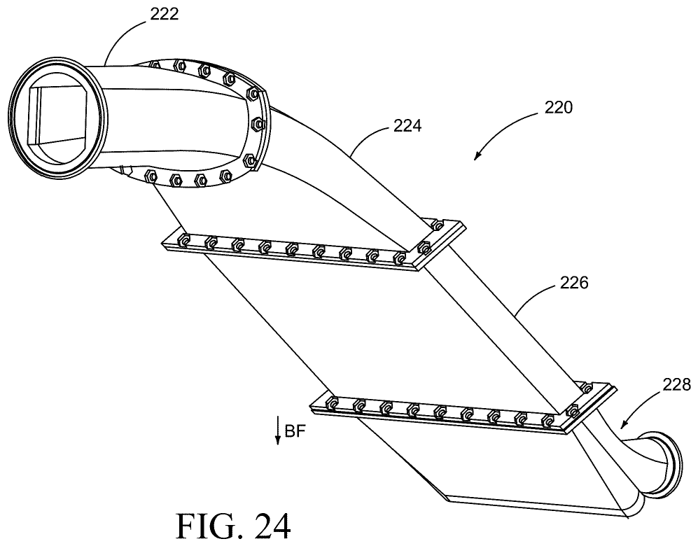

The present disclosure will be described with reference to FIGS. 1-24. Referring first to FIGS. 1 and 2, a cross section of a materials separator assembly 10, and an isometric view of the same separator is shown respectively. In accordance with example implementations, the flow of materials can proceed along the Z axis and along slide surface 12. In this implementation, the Y axis can be the direction of body forces (BF), for example gravitational forces. Slide surface 12 can be angled other than normal to both the Y and X axis. As shown, slide surface 12 can be angled other than normal to the body forces.

Slide surface 12 can be exposed along the Y axis to engage materials traversing separator assembly 10. Slide surface 12 can be angled at an incline plane in relation to the Y axis or a decline plane in relation to the X-axis. It is understood that rotation of the separator along the Z-axis can change the Y-axis for the X-axis. This rotation would realign the separator in relation to body forces as will be shown in other implementations.

Material 14 can proceed through separator assembly 10 along the Z-axis for example. Material 14 can be flowable and be a mixture of components having different physical properties (e.g., size, density, condensed (liquid or solid), non-condensed). The mixture can include one or more of fluids, fluids and solids, liquids, liquids and solids, liquids and cells, liquids and flocculants, solids, and/or emulsificants. Accordingly, the mixture can include components of different phases. Solids within the mixture can include one or more of sand, oil, sticky particles that agglomerate, salt cake simulant, abrasive polydispersed particles, slurry with particles spheres, irregular particles, silica, oil-water mixture with solid particles, algae, and/or emulsions.

Components 16 of material 14 can be provided to separator assembly 10 as a relatively uniform mixture or not. Upon traversing separator assembly 10 along slide surface 12 components 16 can migrate along the surface either away from or toward the X-axis. For example, where components have a density greater than the media they reside in, they migrate toward the X-axis; where components have a density less than the media they reside in, they migrate away from the X-axis. Components that migrate toward the X-axis can exit separator assembly 10 more concentrated in one portion 18 of material 14 than another portion 20. Components that migrate away from the X-axis can be removed from the upper portion of the separator assembly.

Accordingly, the separator assemblies of the present disclosure can include a conduit system configured to be arranged in relation to body forces. The system can include at least one linear section 11. The linear section can include a length of opposing sidewalls 412 defining a volume 15 configured to receive a flow of mixed materials 14 entering along a proximate end 17 of the length, proceeding along the length, and exiting along a distal end 19 of the length.

Within section 11 can be an exposed body force slide surface 12. The slide surface can extend at an angle other than normal to the body forces. As will be shown and depicted, slide surface 12 can be part of the sidewall of the conduit, slide surface 12 can extend form a sidewall of the conduit, and/or slide surface 12 can extend from a member within the conduit. The separator assemblies of the present disclosure can be coupled with other separator assemblies, including, but not limited to parallel assemblies, material mixing and/or introduction assemblies, and/or exit assemblies. Slide surface 12 can have a length along the linear section of the conduit that is greater than a width within the conduit.

Separators of the present disclosure can reduce the distance that a particle may need to settle in order to reach a lower portion of the conduit such as the bottom of the conduit or pipe invert which can be a substantial advantage. The separator assemblies may be further leveraged to utilize the Boycott effect which can reduce the time particles may take to settle. This combination can be important because as the concentration of particles increases, hindered settling typically increases the settling time and thereby increases equipment size, but with implementations of these separators higher concentration particles settle similarly to dilute particles.

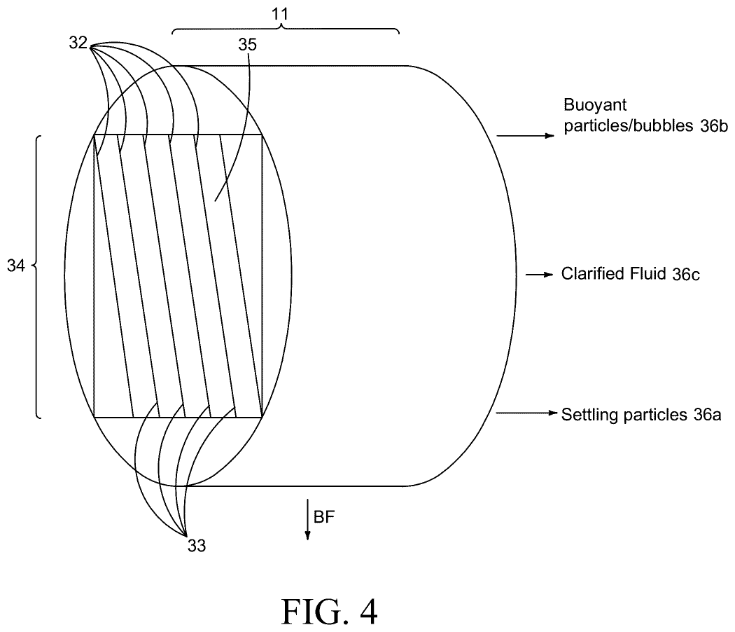

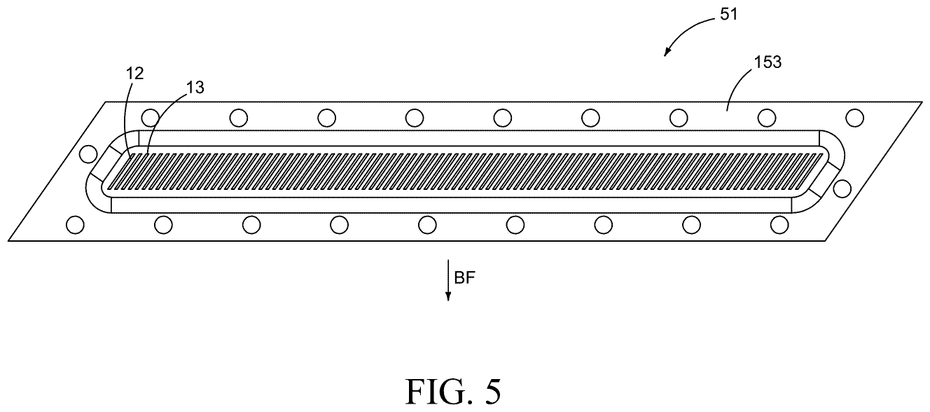

Referring next to FIGS. 3 and 4, in one embodiment, a separator assembly 30 can include a series or plurality of angled plates 35 that are defined by body force slide surface 32 and under surface 33. This series of angled plates can extend from sidewalls of a conduit to another sidewall of the conduit to form individual conduits having opposing sidewalls 35 and 33. Components of material 34 can include settling particles 36a and buoyant particles/bubbles 36b within a fluid, for example. Upon traversal of separator assembly 30, particles 36a can accumulate or concentrate toward the lower portion of slide surface 32 while buoyant particles/bubbles 36 can accumulate or concentrate toward the upper portion of slide surface 32 thereby providing separation. Fluid of material 34 can have both buoyant particles/bubbles 36b and settling particles 36a removed therefrom to form a clarified fluid 36c.

In accordance with example implementations, a mixture of components 34 can be provided to a conduit having an exposed body force slide surface 12 or 33 within linear section 11 of the conduit. Components of the mixture can be separated upon the slide surface to form separated components of the mixture; for example one or more of components 36a, 36b, or 36c.

In accordance with at least one embodiment, the bottoms and/or tops of the space between plates 35 can be open to allow settled particles to accumulate in a conduit invert or conduit bottom, and buoyant particles accumulate at the top of the pipe or conduit (here particle may refer to bubbles as well). These openings can be referred to expressways. In one embodiment, the settled or buoyant particles can be collected into one process stream that is separate from another process stream.

In accordance with another embodiment, the slide surface of the plates may be coated so as to extract material as fluid flows past. For example, some rare metals may be present in low concentrations but turn a profit if collected. Similarly, some species in wastewater must be removed prior to further use or disposal and available surfaces may make this feasible with an insert changeout schedule.

The separators of the present disclosure can use short settling distances and/or the Boycott effect to achieve particle/bubble removal. In contrast to plate separators where flow opposes settling, in these mesofluidic settlers, flow can be primarily (perhaps not exclusively) orthogonal or normal (along the Z-axis) to the settling vector (along the Y-axis, or body force) so that settling and pipe conduit flow occur in distinct directions. This permits much faster flowrates than may be achieved in a plate settler. Smaller settler dimensions may permit substantially faster flowrates for the same efficacy.

Industrial applications and advantages include rapid removal of settling solids from petroleum settling ponds; rapid separation of plastics for recycling; faster smaller footprint floatation, settling, and flocculating equipment; and that plates within the device may be used to achieve reactions or other functions.

While it is possible to have significant settling under turbulent flow conditions where eddies drive vertical mixing, significant flowrates may be achieved with laminar flow where turbulent mixing is negligible. Because plates are used within the device, even higher flowrates can be achieved than would be possible were the plates absent.

The separators of the present disclosure may utilize the Boycott effect but with process flows arranged orthogonal (perhaps not exclusively) to the plane in which the Boycott induced flows occur. These configurations can accelerate particle separation and do so at faster flowrates than has previously been accomplished, which in turn permits smaller process and environmental footprints. The slide surfaces can be configured as plates to form a series of parallelograms (as shown in FIGS. 3 and 4, for example), imposing a 30° to 65° angle with respect to vertical, Y-axis, and/or body force.

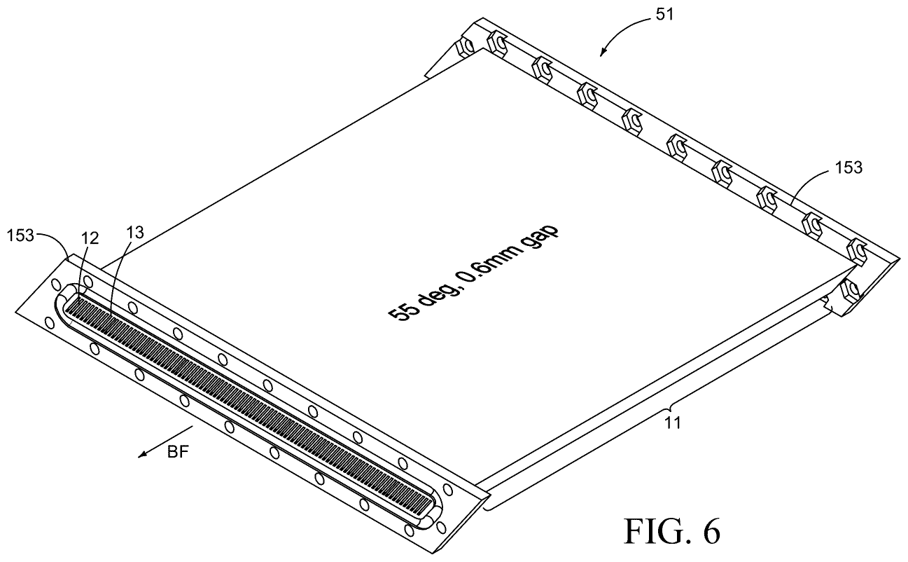

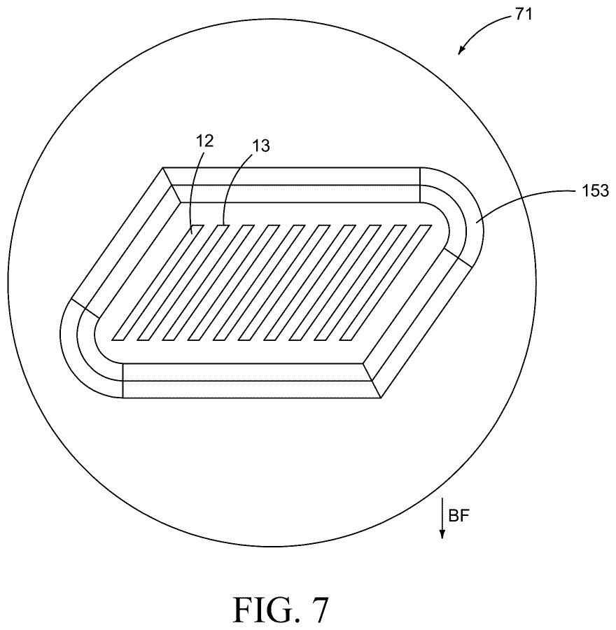

With respect to FIG. 5, an end view of assembly 51 is shown that includes a plurality of conduits 13. Each of conduits 13 is defined by a body force slide surface 12. As shown, the slide surfaces are angled other than normal to the body force. Assembly 51 can include coupling interfaces 153 configured to couple with other assemblies to form a system. FIG. 6 depicts an isometric view of assembly 51 having the flow of materials from left to right across the sheet. In this implementation the angle of body force slide surface 12 in relation to body force is 55 degrees and there is a 0.6 mm gap between conduits 13 or the plates forming the conduits have 0.6 mm width.

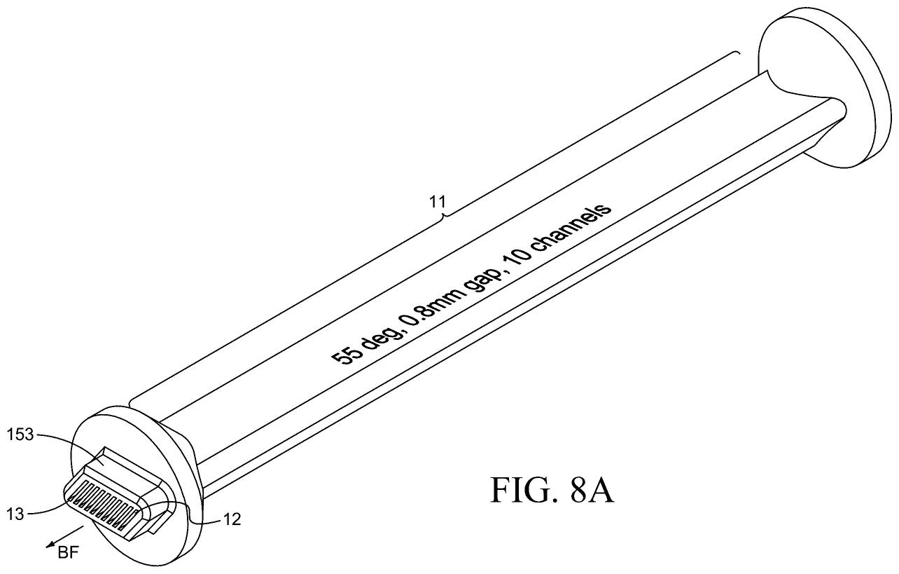

With respect to FIG. 7, an end view of assembly 71 is shown that includes a plurality of conduits 13. Each of conduits 13 is defined by a body force slide surface 12. As shown, the slide surfaces are angled other than normal to the body force. Assembly 71 can include coupling interfaces 153 configured to couple with other assemblies to form a system.

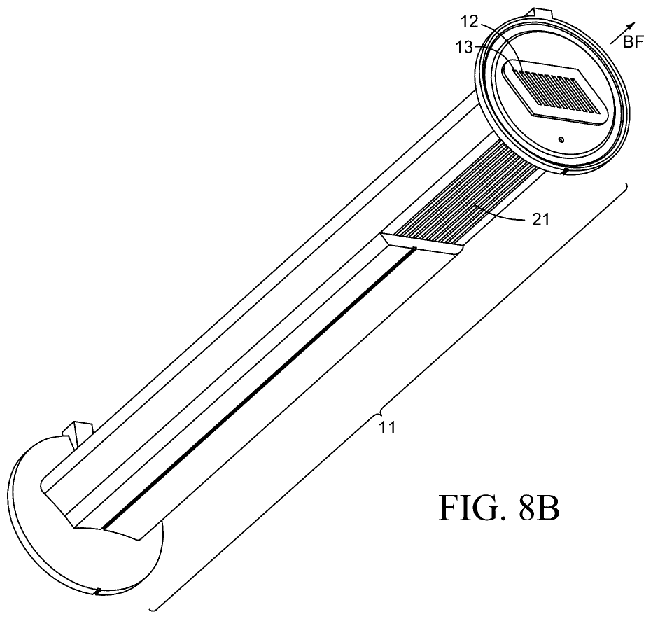

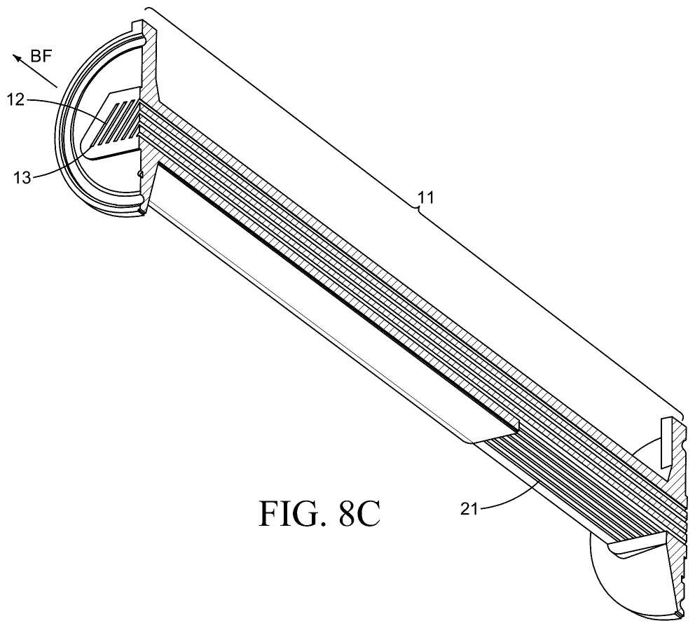

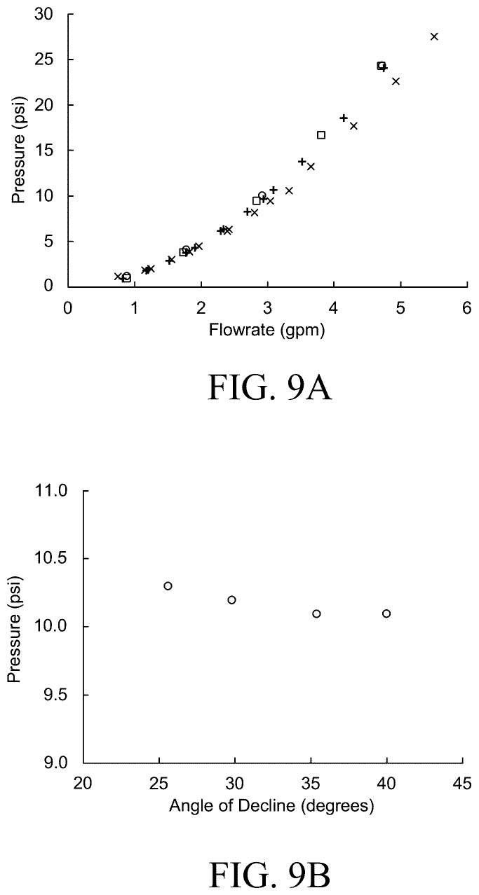

FIGS. 8A-8C depict isometric views of assembly 71 having the flow of materials from left to right across the sheet. In these implementations the angle of body force slide surface 12 in relation to body force is 55 degrees and there is a 0.6 mm gap between conduits 13 or the plates forming the conduits have 0.6 mm width. As depicted in FIGS. 8B and 8C, assembly 71 can include opening 21. This opening can be defined by removal of a lower portion of the sidewall of assembly 71. In accordance with example implementations, the opening can provide an exit path for concentrate formed after interaction with the slide surface.

These separation assembly configurations can provide a short settling path in the rate limiting settling step and a fast avalanche effect thereafter. The sides of the device can be 2.5 cm at the base and 5 cm along the sidewall (or hypotenuse with respect to a triangle formed by the base, side wall, and height). Approximately 6 inch conduit segments can be coupled together to achieve a desired length of the separator assembly. Flow into and out of the conduit can be provided by one inlet and proceed to two outlets, each of which can have a tube diameter of ⅜^{th} of an inch (except in one instance where the bottom outlet had a diameter of ¼^{th} of an inch). The inlet typically comprised a 10° cone from the fitting that expanded to match conduit cross section, though a shorter 20° cone was also explored. The upper outlet was designed for particle depleted flow and the lower inlet was designed to convey particle enriched flow.

Spherical particles were selected for these tests. They had a density of 4.2 g/mL and a diameter of 63-75 microns (Isospheres XLDH063075B, XL Sci-Tech, Inc. Richland, WA). Particles were selected for visibility. Particles were suspended in a small amount of water and shaken to remove attached bubbles. Once well mixed, the particles were added to a mixing tank, from which fluid flows to the device that then returns to the mixing tank.

In testing, flow is oriented perpendicular to the parallelogram (along the Z axis). A Rotary Lobe pump (Viking Sterilobe SLAS, Cedar Falls, IA) was used to generate flowrates of 1-5 gpm. The lower end was selected to ensure that particles do not settle in the tubes leading to or from the device. The upper end is selected to ensure that flow through the device remains in the laminar flow regime to minimize particle resuspension.

For the 63-75 micrometer particles in water flowing at 2.8 gpm, for example, the device should span <23 inches. Additional lengths may be helpful to provide extra operating margins, but shorter dimensions (18 inches) were used to demonstrate these phenomena and their transitions.

There can be at least two regions of interest with the second downstream of the first. The first region comprises an entrance region in which the entering flows are becoming well developed (a fluid dynamics term of art) and settling has begun but remains insufficient to concentrate particles arriving at the diagonal wall to induce an avalanche. In the second region, settling has commenced in earnest such that particle concentration along the exposed body force slide surface is sufficient to induce an avalanche. These avalanches cause particles to cascade down the inclined slide surface in an intermittent fashion from the Boycott effect with particles building up until an avalanche clears them only to build up again. Some particles may or may not be stuck in the grooves in the slide surface that may remain from the 3D printing process but the avalanche proceeds anyway. A settled bed forms at the base of the conduits which can indicate the location of avalanches. In accordance with example implementations, the Z-axis of the separation assembly can be arranged at an angle other than normal to the Y-axis or the body force. This configuration can permit the settled bed to exit the assembly.

The first section mentioned above can support a recirculating flow, depending on the angle of expansion. The jet flow from the beginning of the inlet fitting can expand to the full width of the device and become well developed but if the expansion is too rapid, a significant recirculation pattern may develop in the interim. This entrance flow can be trimmed by decreasing the angle of the expansion cone originating at the entrance fitting so that the expansion is more gradual. This recirculation can serve an important purpose by ensuring that the particles are well mixed.

When the device is oriented horizontally (normal to BF), the settled bed within the device can form a fixed bed. That the settled bed remains fixed and very few if any particles make it out of the device can indicate how influential the Boycott effect is even when the total length of the device is less than a meter. Under these conditions there can be a resuspension of the particles that then simply builds up toward the end.

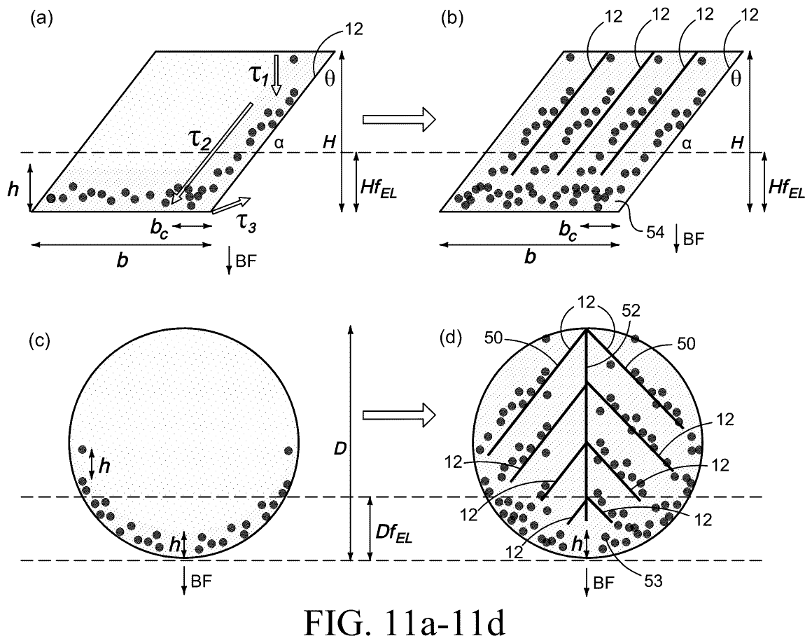

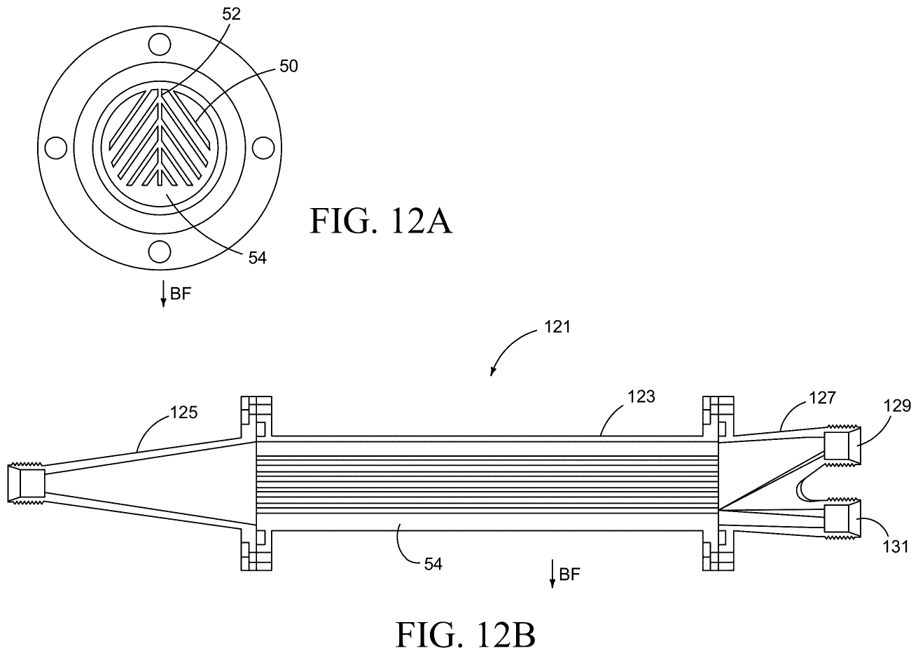

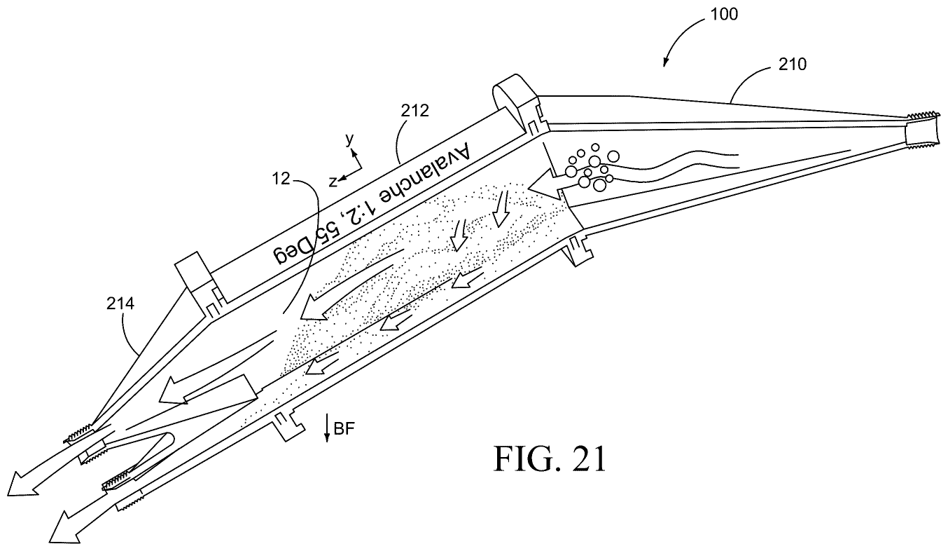

Removing these particles to prevent clogging of the device can be accomplished by lowering the exit with respect to the entrance (e.g. FIGS. 12B, 21, and 22). At modest angles, the bed remains fixed. However, as the angle of BF in relation to the Z-axis approaches ˜30° the fixed bed becomes a sliding bed (See, e.g. FIG. 21). The bed slides slowly at first, but as the angle further increases the bed slides faster and perhaps even induces a second avalanche. At these higher flowrates there may be additional resuspension, which decreases the particles headed toward the slurry exit, decreasing the separation efficiency marginally. Changing the declination angle only marginally affects the pressure drop.

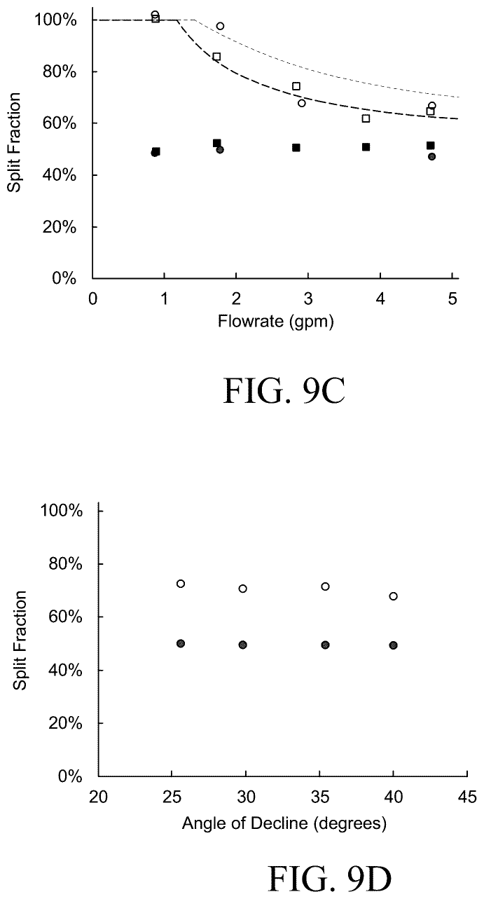

The data depicted FIGS. 9A-9D demonstrate the importance of flowrates in some embodiments. Across all flowrates, the fraction of the flow that goes out each outlet is approximately the same (the outlet fittings, tube diameters, and tube lengths are approximately the same). Flow following particles would be expected to partition evenly between the two outlets. At low flowrates, however, the fraction of particles coming out of the lower outlet is almost correct. The lowest flowrate is determined by settling in the lines outside of the settler. As the flowrate increases, the beginning of the avalanche region is delayed and separation becomes imperfect, although there is significant amount of avalanche driven settling that has occurred. Particle resuspension may also play a role. In principle a longer separator may permit higher split fractions at higher flowrates. Yet, industrially 18 inches remains modest.

FIG. 9A shows pressure versus flowrate for ˜33° of declination for slurry (circles and squares) and water (+'s and x's) and for surface angles of 0° (control, blue) and 35° (red) with respect to vertical. FIG. 9B shows pressure versus angle of decline with respect to horizontal at 2.8 gpm for water for slurry with a 35° surface angle with respect to vertical. FIG. 9C shows split fraction into express lane versus flowrate for ˜33° of declination and versus FIG. 9D shows angle of declination with respect to horizontal for 2.8 gpm for slurry (closed symbols) and solids only (open symbols) for sidewall angles of 0° (blue squares) and 35° (red circles) with respect to vertical. Model for ν=1·10⁻⁶ m²/s, ρₛ=4200 kg/m³, ρ_{w}=1000 kg/m³, θ=35° with respect to horizontal, d=63 μm, f_{EL}=0.5, and Lₛ=˜12 inches (removing the mixing region from the total internal length of 18 inches).

Prior Boycott separators are very different from the present methods and assemblies. In these prior separators, the flow is in the same plane as the separator, which limits the maximum flowrate because flowrates faster than the settling rate led to unsettled particles overflowing into the pure liquid stream. Settling of the smallest particle of interest must be complete to ensure that the outlet fluid is particle free. In the present configuration, the flowrates are not so bounded. Removing this limitation permits faster flowrates or correspondingly more compact devices. These assemblies and methods may be numbered up to achieve even higher flowrates. Higher flowrates and more compact devices suggest that these assemblies and methods may be useful for process intensification and reduction of environmental footprints of processing equipment.

Particles <10 microns in size can be removed from flow. Additionally, adding large particles into the device may accelerate small particle removal. The combination of these variables and approaches permits particles of the size of 5 microns, 5-10 microns, EMB 10 particles (<10 microns), 13 microns, 7-10 microns, 30-50 microns in diameter to be removed.

Two types of spherical particles were selected for tests. Both had a density of 4.2 g/mL and diameters of 38-45 microns (Soda Lime Glass Spheres GL0191B5/38-45, Mo-Sci Online, Rolla, MO) and 63-75 microns (Isospheres XLDH063075B, XL Sci-Tech, Inc. Richland, WA). Particles were selected for visibility. Particles were suspended in a small amount of water and shaken to remove attached bubbles. Once well mixed, the particles were added to a mixing tank, from which fluid flows to the device that then returns to the mixing tank.

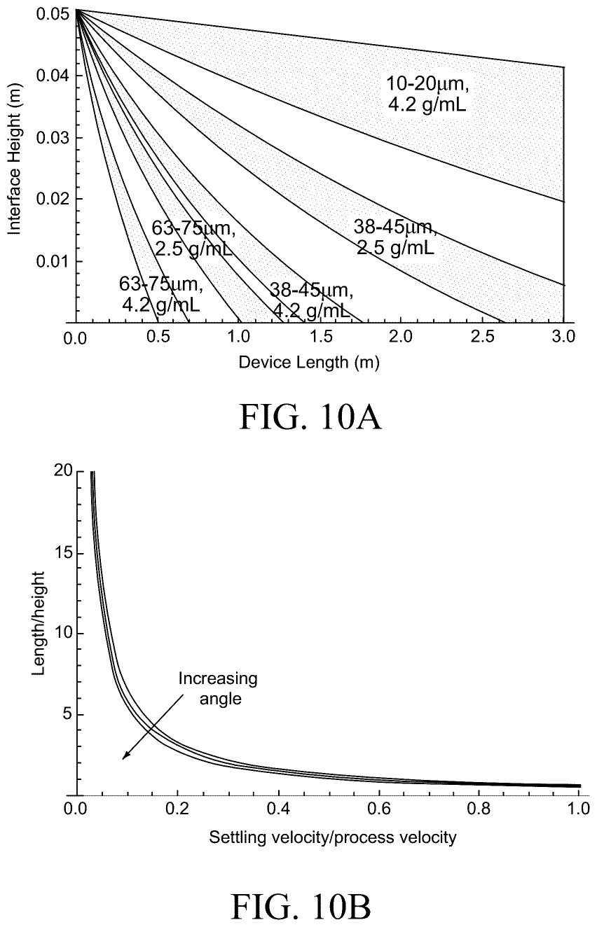

With respect to FIGS. 10A-10C, device parameters and separation results are shown. FIG. 10A shows modeled interface as a function of position for 55°, 2 inch tall, 1 inch base, 2.8 gpm experiment assuming dilute suspension. FIG. 10B shows device length to complete settling scaled on device height as a function of the settling velocity to bulk flow velocity for b/hₒ=0.5 and θ=35°, 55°, and 75°. FIG. 10C shows device length to complete settling scaled on device height as a function of the settling velocity to bulk flow velocity for b/hₒ=0.125, 0.25, and 0.5 and θ=55°.

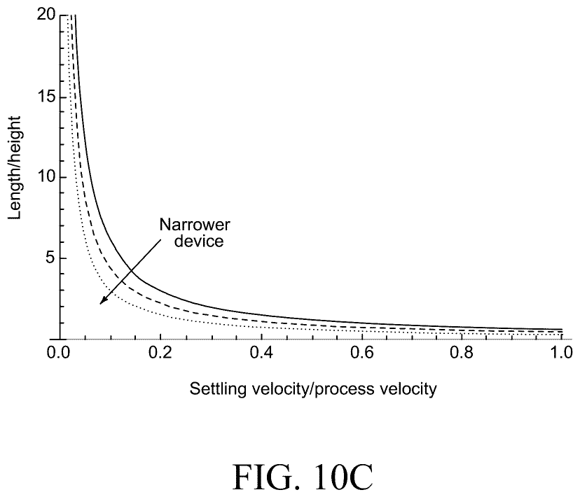

Referring next to FIGS. 11a-11d, embodiments of separator assemblies that include Boycott functional fins (BFFs) 50 within tessellated structures are provided. In accordance with the above configurations and descriptions, slide surfaces 12 can be provided. These slide surfaces can be part of plates that terminate to an opening thus forming fins 50. Conduits can include fins 50 that extend from a support member 52 and terminate in an opening that forms an expressway 54.

These configurations can decrease the device length while increasing the throughput of these devices.

In accordance with the embodiments of FIGS. 11a-11d, particles 53 that exit the express lane are shown for these configurations. The parallelogram configuration is shown in FIGS. 11a-11d. Two mechanisms may lead to particles exiting the bottom exit. First, particles may be simply swept from entrance to the bottom exit; this is composed of two groups of particles: those that have settled either along the angled sidewall or directly to the bottom of the channel, and those that remain suspended within the fluid taken into the express lane. This is an estimate because the average flow velocities are used throughout regardless of slip or no-slip boundary conditions. The base of the channel as b and the diagonal sidewall length as a. The height of the parallelogram is H=a cos θ and the portion of the channel that goes into the express lane is Hf_{EL}b, where f_{EL} is the fraction of the vertical height that partitions to the express lane. Settling over a given distance induces particles to fall a distance of h=vₒt=vₒLₛ/u, where vₒ is the settling velocity, t is the time a particle is in the settling region of the device, Lₛ is the length of the separating zone, and u is the cross-sectional average velocity. This settling clears a horizontal distance of particles of b_{c}=h tan θ. The cross-sectional area of particles cleared adjacent to the diagonal sidewall is then Hb_{c}. The cross-sectional area of particles cleared adjacent to the bottom of the channel that are at least a distance of b_{c} away from the sidewall are h (b−b_{c}). The cross-sectional area of particles that remain suspended less those within the lateral distance of the sidewall b_{c} is Hf_{EL} (b−b_{c}).

FIGS. 12A and 12B depict an implementation of fins 50 supported by member 52 above expressway 54. FIG. 12B is a cut-away along the Z-axis incorporating fins 50. Material flows from left to right in this view providing a concentrate through outlet 131 associated with expressway 54. As shown system 121 can include an entrance assembly 125 coupled to a separation assembly 123 and an outlet assembly 127. Outlet assembly 127 can have an upper outlet 129 configured to convey permeate and a lower outlet configured to convey concentrate.

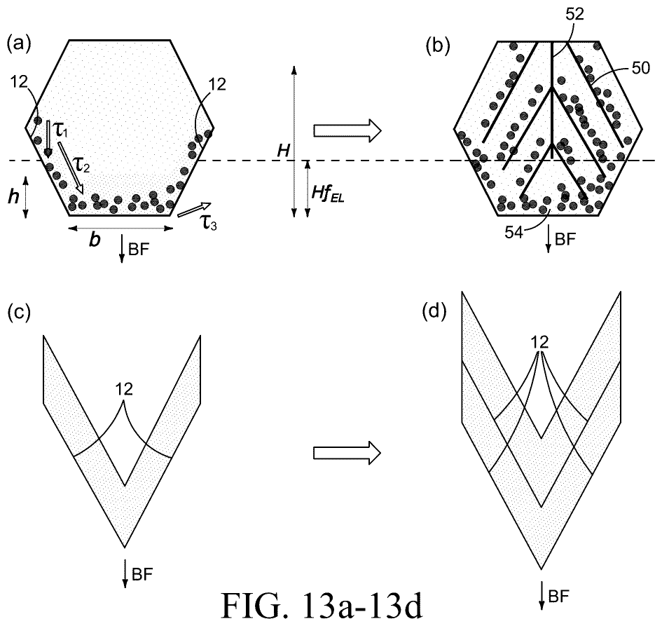

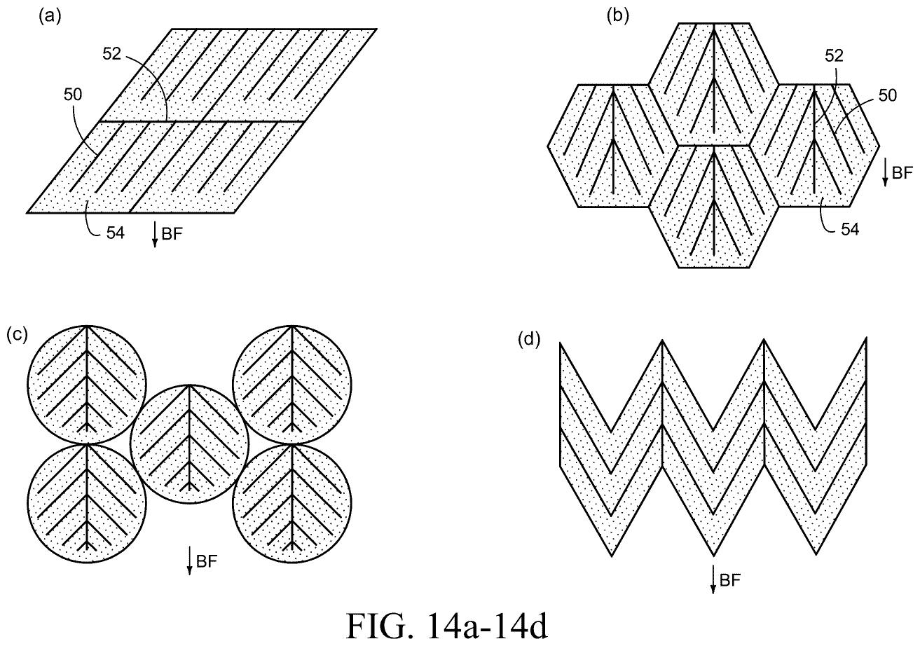

In accordance with the configurations depicted in the FIGS. 13a-14d herein, many shapes can be used to prepare these separators including cross sectional shapes include those that tesselate such as triangles, quadrilaterals, and hexagons. As shown, these assemblies can be stacked and/or aligned lateral of one another.

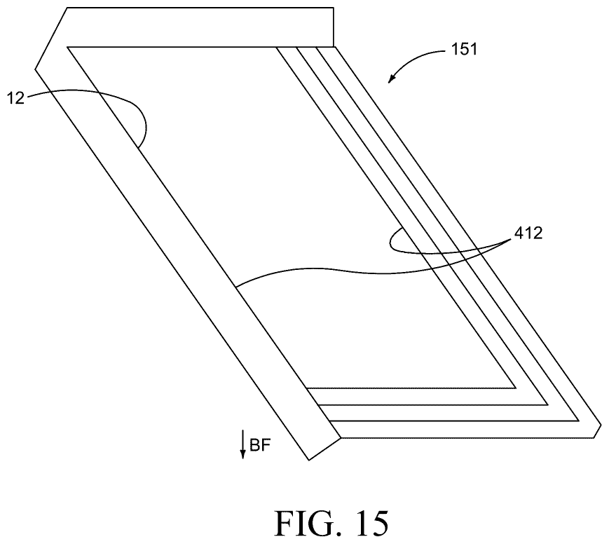

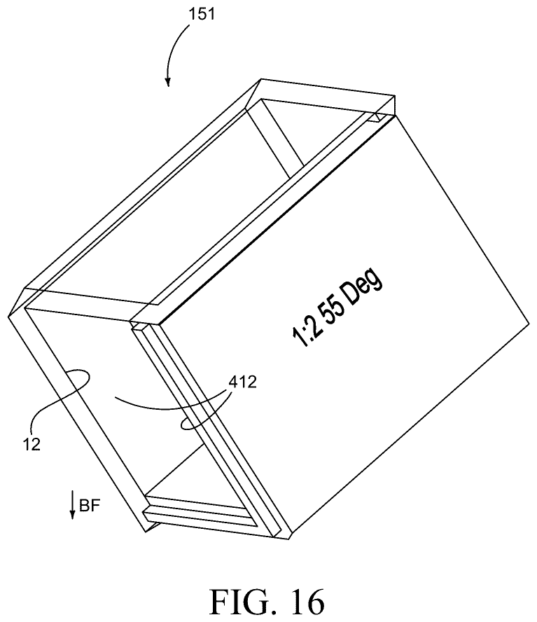

Referring next to FIGS. 15 and 16, separator assembly 151 is a single conduit wherein slide surface 12 is a part of the sidewall of the conduit.

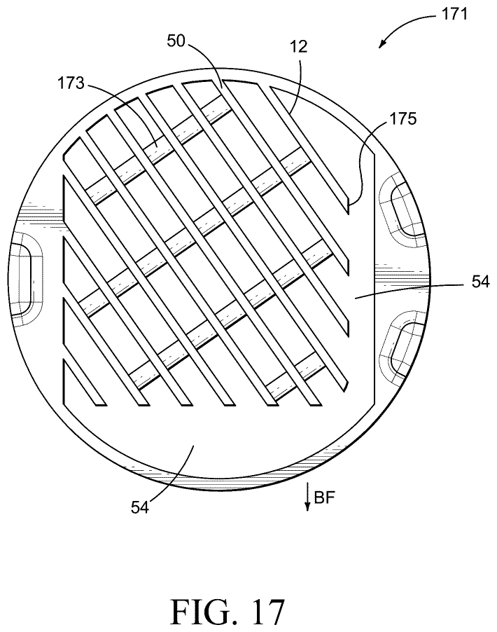

Referring next to FIGS. 17-19, assembly 171 is shown that includes a plurality of fins 50 each defining slide surfaces 12 that can be separated/supported by posts 173. Surfaces 12 can terminate at an edge 175 within an expressway 54. In this embodiment a lateral expressway is provided as well.

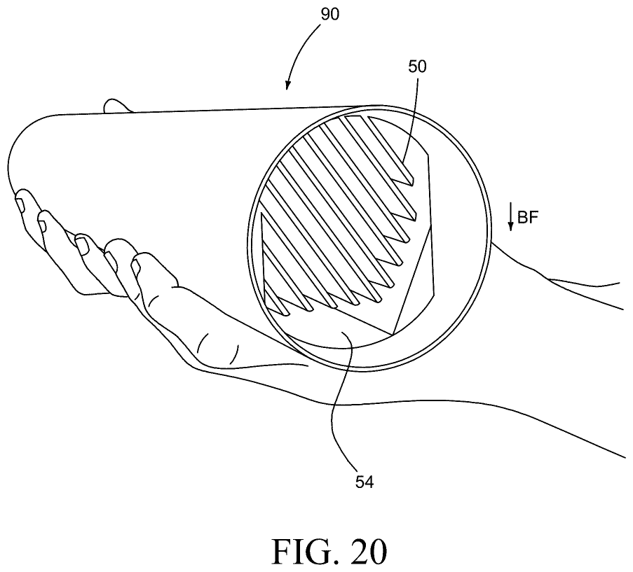

Referring to FIG. 20, a separator assembly 90 is shown having fins 50 extending from a sidewall of conduit to an expressway 54.

Referring to FIG. 21, in another embodiment, system 100 is provided that includes entrance assembly 210 coupled to separator assembly 212 coupled to outlet assembly 215. These assemblies can be arranged in relation to the body forces. For example, the linear axis of the entrance assembly 210 can be relatively normal to the body forces, while the linear axis of separator assembly 212 can be angled other than normal in relation to the body forces. Outlet assembly 214 can be consistent with the linear angle of separator assembly 212. As depicted assembly 212 can have an angled linear direction in relation to the Z-axis with at least one slide surface 12 exposed through this cut away view. In this arrangement, the exposed body surface remains at an angle other than normal to the body forces, but also remains and an angle in relation to the Y and/or Z axis.

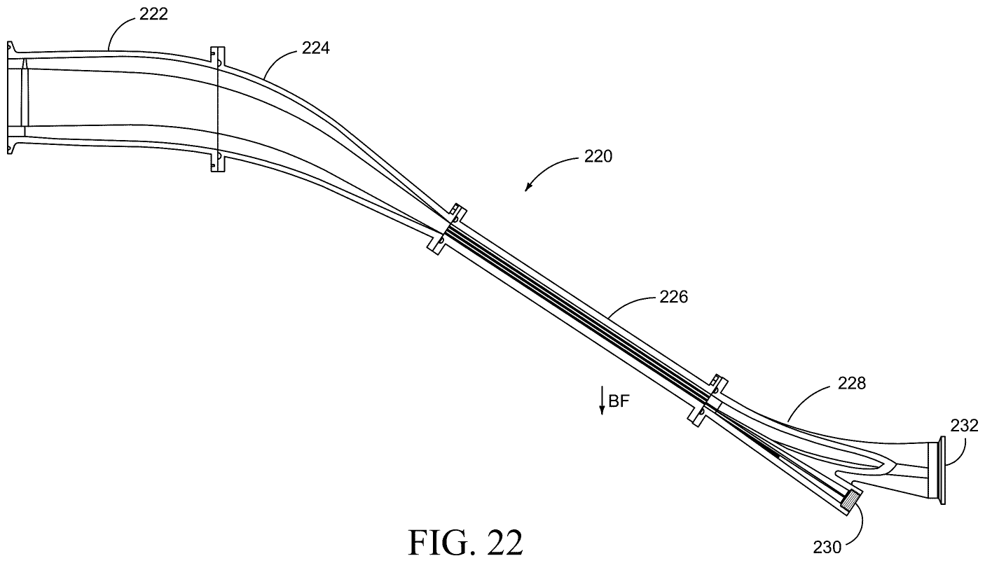

With reference to FIGS. 22-24 a system 220 is shown that includes entrance conduit assemblies 222 and 224 coupled to separation assembly 226 which is coupled to exit assembly 228. As shown, assembly 222 can be normal in relation to body forces. Assembly 224 can be arranged other than normal in relation to body forces then couple to assembly 226 which is arranged other than normal to body forces. Assembly 226 can, for example, be as shown in FIGS. 5 and 6 above. Additionally, system 220 can include outlet assembly 228. Outlet assembly 228 can include a lower outlet 230 configured to receive concentrate and upper outlet 232 configured to receive permeate.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect.

The invention claimed is:

1. A materials separator assembly, the assembly comprising:
a conduit system configured to be arranged in relation to body forces, the system comprising at least one linear section, the at least one linear section comprising a length of opposing sidewalls defining a volume configured to receive a flow of mixed materials entering along a proximate end of the length, proceeding along the length, and exiting along a distal end of the length; and
an exposed body force slide surface within the linear section, the slide surface extending at an angle other than normal to the body forces.

2. The assembly of claim 1 further comprising a plurality of exposed body force slide surfaces within the linear section.

3. The assembly of claim 2 wherein each of the slide surfaces within the linear section extend at the same angle in relation to the body forces.

4. The assembly of claim 1 wherein the slide surface defines a length within the linear section that is greater than a width.

5. The assembly of claim 1 wherein the slide surface extends from a sidewall of the conduit.

6. The assembly of claim 5 wherein the slide surface terminates at another sidewall of the conduit.

7. The assembly of claim 5 wherein the slide surface terminates at an edge.

8. The assembly of claim 7 further comprising an expressway defined by another sidewall and exposed to the edge of the slide surface.

9. The assembly of claim 2 wherein each of the plurality of slide surfaces defines a plate.

10. The assembly of claim 9 wherein each of the plates extends from a central member extending from a sidewall of the linear section.

11. The assembly of claim 1 wherein the slide surface defines at least a portion of a sidewall of the linear section.

12. The assembly of claim 1 wherein the linear section is arranged at an angle in relation to the body forces.

13. A method for separating components of a mixture, the method comprising:
providing a mixture of components to a conduit having an exposed body force slide surface within a linear section of the conduit, the slide surface extending at an angle from one of the other than normal to the body forces acting upon the conduit; and
separating components of the mixture upon the slide surface to form separated components of the mixture.

14. The method of claim 13 further comprising providing a first portion of components through an upper portion of the conduit in relation to the body forces and providing a second portion of components through a lower portion of the conduit in relation to the body forces.

15. The method of claim 14 wherein the first portion of components comprises buoyant particles/bubbles, and the second portion of components comprises settling particles.

16. The method of claim 14 further comprising providing a third portion of components through a middle portion between the upper and lower portions of the conduit in relation to the body forces.

17. The method of claim 13 wherein the first portion of components comprises buoyant particles/bubbles, the second portion of components comprises settling particles, and the third portion of components comprises clarified fluid.

18. The method of claim 13 further comprising providing the mixture to a plurality of exposed body force slide surfaces.

19. The method of claim 18 wherein the conduit comprises an entrance in fluid communication with the plurality of exposed body force slide surfaces.

20. The method of claim 13 further comprising providing at least some of the separated components of the mixture to an expressway within the conduit.

21. The method of claim 13 wherein the slide surface defines at least a portion of the sidewall of the conduit.

22. The method of claim 13 further comprising arranging the linear section and angle other than normal to the body forces.
